(19) United States
(12) Patent Application Publication
(10) Pub. No.: US 2004/0198905 A1
(43) Pub. Date: Oct. 7, 2004

(54) Method for preparing organically modified organopolysiloxanes

(76) Inventors: Hideyuki Mori, Fukui Prefecture (JP); Toyohiko Yamadera, Chiba Prefecture (JP); Mitsuo Hamada, Chiba Prefecture (JP)

Correspondence Address: MCKELLAR STEVENS & HILL PLLC, POSEYVILLE PROFESSIONAL COMPLEX, 784 SOUTH POSEYVILLE ROAD, MIDLAND, MI, 48640, US

(21) Appl. No.: 10/483,148

(22) PCT Filed: Jun. 28, 2002
(86) PCT No.: PCT/JP02/06619

(30) Foreign Application Priority Data
Jul. 23, 2001 (JP) 2001-221343

(51) Int. Cl. C08L 83/05

(52) U.S. Cl. 524/861; 524/588

(57) ABSTRACT

A solventless method for the preparation of organically modified organopolysiloxanes comprising a hydrosilylation reaction of (A) liquid organopolysiloxane that contains at least one silicon atom-bonded hydrogen atom in each molecule with (B) a non-silicone liquid organic compound that contains at least one aliphatic carbon-carbon double bond in each molecule in the presence of a (C) a hydrosilylation reaction catalyst, where the hydrosilylation reaction is carried out in a dispersion of component (B) in component (A) or of component (A) in component (B) having a microparticulate form of average particle size ≧100 μm induced by high-shear agitation of components (A) and (B).

This invention relates to a method for preparing organically modified organopolysiloxanes. More particularly, this invention relates to a very efficient solventless method for preparing organically modified organopolysiloxanes by a hydrosilylation reaction between liquid organopolysiloxane that contains at least one silicon atom-bonded hydrogen atom in each molecule and a non-silicone liquid organic compound that contains at least one aliphatic carbon-carbon double bond in each molecule.

### BACKGROUND

It is already known that organically modified organopolysiloxanes can be prepared by a hydrosilylation reaction between liquid organopolysiloxane that contains at least one silicon atom-bonded hydrogen atom in each molecule and a non-silicone liquid organic compound that contains at least one aliphatic carbon-carbon double bond in each molecule. For example, Japanese Laid Open (Kokai or Unexamined) Patent Application Number Hei 4-46933 (46,933/1992) discloses a method in which the reaction is run in a solvent under increased pressure. Japanese Laid Open (Kokai or Unexamined) Patent Application Number Hei 9-95536 (95,536/1997) discloses a method in which the hydrosilylation reaction is followed by heating under reduced pressure in order to distill off unreacted starting materials. Japanese Laid Open (Kokai or Unexamined) Patent Application Number Hei 9-208622 (208,622/1997), and its equivalent, U.S. Pat. No. 6,121,379, discloses a method in which a hydrosilylation reaction of the aforementioned type is run in the presence of an oxidation inhibitor. Japanese Laid Open (Kokai or Unexamined) Patent Application Number Hei 11-322939 (322,939/1999), and its equivalent, U.S. Pat. No. 5,986,022, discloses a continuous method for the preparation of organically modified organopolysiloxanes. Japanese Laid Open (Kokai or Unexamined) Patent Application Number 2000-327717 discloses a method in which a hydrosilylation reaction of the aforementioned type is accelerated by the introduction of an oxygen-containing gas into the reaction system.

The methods described above, however, suffer from a slow hydrosilylation reaction and poor production efficiency in the absence of organic solvent compatible with both the liquid organopolysiloxane containing at least one silicon atom-bonded hydrogen atom in each molecule and the non-silicone liquid organic compound containing at least one aliphatic carbon-carbon double bond in each molecule. Examples of such solvents are alcohols such as ethyl alcohol and isopropyl alcohol and aromatic solvents such as benzene, toluene, and xylene. On the other hand, the use of organic solvent imposes the requirement that the organic solvent be removed post-reaction.

The object of this invention is to provide a very efficient solventless method for preparing organically modified organopolysiloxanes by the hydrosilylation reaction between liquid organopolysiloxane that contains at least one silicon atom-bonded hydrogen atom in each molecule and a non-silicone liquid organic compound that contains at least one aliphatic carbon-carbon double bond in each molecule.

### THE INVENTION

The present invention is a solventless method for the preparation of organically modified organopolysiloxanes comprising a hydrosilylation reaction of

(A) liquid organopolysiloxane that contains at least one silicon atom-bonded hydrogen atom in each molecule with

(B) a non-silicone liquid organic compound that contains at least one aliphatic carbon-carbon double bond in each molecule in the presence of

(C) a hydrosilylation reaction catalyst,

where the hydrosilylation reaction is carried out in a dispersion of component (B) in component (A) or of component (A) in component (B) having a microparticulate form of average particle size ≧100 μm induced by high-shear agitation of components (A) and (B).

The method of this invention for preparing organically modified organopolysiloxanes will be explained in detail hereinbelow.

The liquid organopolysiloxane (A) should contain at least one silicon atom-bonded hydrogen atom in each molecule. The molecular structure of this component is not critical and component (A) can have, for example, a straight chain, partially branched straight chain, branched chain, cyclic, network, or resin molecular structure. Straight chain molecular structures are preferred. The bonding position for the silicon-bonded hydrogen in component (A) is not critical, and the silicon-bonded hydrogen can be bonded, for example, in terminal and/or pendant position on the molecular chain. The silicon-bonded organic groups in component (A) should be aliphatically unsaturated bond-free monovalent hydrocarbon groups such as alkyl groups, e.g., methyl, ethyl, propyl, butyl, pentyl, hexyl, heptyl, 2-ethylhexyl, dodecyl, and octadecyl; aryl groups, e.g., phenyl, tolyl, xylyl, and naphthyl; aralkyl groups, e.g., benzyl and phenethyl; and halogenated alkyl groups such as chloromethyl, 3-chloropropyl, 3,3,3-trifluoropropyl, and 3,3,4,4,5,5,5-heptafluoropentyl. Methyl and phenyl are preferred for the silicon-bonded organic groups in component (A). Component (A) should be a liquid at the reaction temperature, and, for example, the viscosity at 25° C. is preferably 1 to 1,000,000 mm²/s and particularly preferably 1 to 100,000 mm²/s.

The liquid organopolysiloxane (A) is exemplified by liquid straight chain organopolysiloxanes with the following general formula

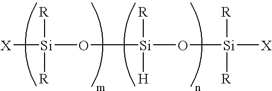

such as trimethylsiloxy-endblocked methylhydrogenpolysiloxanes, trimethylsiloxy-endblocked dimethylsiloxane-methylhydrogensiloxane copolymers, trimethylsiloxy-endblocked dimethylsiloxane-methylhydrogensiloxane-methylphenylsiloxane copolymers, dimethylhydrogensiloxy-endblocked dimethylpolysiloxanes, dimethylhydrogensiloxy-endblocked dimethylsiloxane-methylphenylsiloxane copolymers, and dimethylhydrogensiloxy-endblocked methylphenylpolysiloxanes; liquid cyclic organopolysiloxanes with the following general

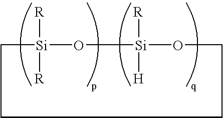

formula such as cyclic methylhydrogensiloxanes and cyclic methylhydrogensiloxane-dimethylsiloxane copolymers; liquid branched chain organopolysiloxanes such as organopolysiloxane copolymers comprising the R₂HSiO_{1/2} siloxane unit, R₂SiO_{2/2} siloxane unit, and RSiO_{3/2} siloxane unit, and organopolysiloxane copolymers comprising the R₃SiO_{1/2} siloxane unit, RHSiO_{2/2} siloxane unit, and RSiO_{3/2} siloxane unit; and liquid resin organopolysiloxanes such as organopolysiloxane copolymers comprising the R₃SiO_{1/2} siloxane unit, R₂HSiO_{1/2} siloxane unit, and SiO_{4/2} siloxane unit, and organopolysiloxane copolymers comprising the R₂HSiO_{1/2} siloxane unit and SiO_{4/2} siloxane unit.

The liquid straight chain organopolysiloxanes are preferred. The group R in the preceding formulas denotes aliphatically unsaturated bond-free monovalent hydrocarbon groups and can be exemplified by the groups already given above. The group X in the preceding formula is the hydrogen atom or an aliphatically unsaturated bond-free monovalent hydrocarbon group; the monovalent hydrocarbon groups encompassed by X can be exemplified by the groups already given above. At least one of the groups X must be the hydrogen atom when the subscript n in the preceding formula is 0. In addition, the subscript m in the preceding formula is an integer with a value of at least 0; the subscript n is an integer with a value of at least 0; and m+n is an integer with a value of at least 1. It is particularly preferred that m be an integer with a value of 1 to 500 and that n be an integer from 0 to 30. The subscript p in the preceding formula is an integer with a value of at least 0; the subscript q is an integer with a value of at least 1; and p+q is an integer with a value of at least 3.

The non-silicone liquid organic compound (B) should contain at least one aliphatic carbon-carbon double bond in each molecule. Its molecular structure is not critical and component (B) can have, for example, a straight chain, partially branched straight chain, branched chain, cyclic, network, or resin molecular structure, among which straight chain molecular structures are preferred. Component (B) should be a liquid at the reaction temperature and, for example, the viscosity at 25° C. is preferably 1 to 1,000,000 mm²/s and particularly preferably 1 to 100,000 mm²/s.

The non-silicone liquid organic compound (B) can be exemplified by alkenyl-functional polyethers such as polyoxyethylenes having allyl at only a single chain end, polyoxypropylenes having allyl at only a single chain end, oxyethylene-oxypropylene copolymers having allyl at only a single chain end, and polyoxyethylenes having allyl at both chain ends; olefins such as 1-hexene, 1-octene, 1-decene, and 1-dodecene; alkenyl-functional polyisobutylenes such as allyl-functional polyisobutylenes; dienes such as 1,5-hexadiene and 1,7-octadiene; and also cyclohexene, allyl glycidyl ether, acrylic acid, methacrylic acid, methyl acrylate, methyl methacrylate, ethyl methacrylate, unsaturated polyesters, and vinyl-functional alkyd resins. Alkenyl-functional polyethers and olefins are preferred.

The quantities of component (A) and (B) addition are not critical in the present method, but component (B) preferably provides from 1 to 1.4 moles aliphatic carbon-carbon double bonds per 1 mole silicon-bonded hydrogen atoms in component (A).

The present method requires that components (A) and (B) be subjected to high-shear agitation so as to induce the dispersion of component (B) in component (A) in a microparticulate form having an average particle size no greater than 100 μm or the dispersion of component (A) in component (B) in a microparticulate form having an average particle size no greater than 100 μm. This requirement arises from the tendency for the hydrosilylation reaction to fail to proceed rapidly unless component (B) is dispersed in component (A) or component (A) is dispersed in component (B) in a microparticulate form having an average particle size no greater than 100 μm.

The following mixing devices are preferred for use in the present method due to their ability to continuously produce high-shear agitation of components (A) and (B) mixtures in which component (B) is dispersed in component (A) or component (A) is dispersed in component (B) in a microparticulate form having an average particle size no greater than 100 μm: known mixing devices such as colloid mills, homomixers, and inline mixers; also, the rotating disk-equipped rotating disk mixer disclosed in Japanese Laid Open (Kokai or Unexamined) Patent Application Number 2000-449 and Japanese Laid Open (Kokai or Unexamined) Patent Application Number 2001-2786.

A hydrosilylation reaction is subsequently carried out in the present method between the silicon-bonded hydrogen in component (A) and the aliphatic carbon-carbon double bonds in component (B) under the effect of the hydrosilylation reaction catalyst (C). The hydrosilylation reaction catalyst (C) is exemplified by platinum, rhodium, and palladium catalysts, with platinum catalysts being preferred. The platinum catalysts are exemplified by platinum supported on finely divided silica, platinum supported on finely divided carbon, platinum black, chloroplatinic acid, alkenylsiloxane complexes of platinum, olefin complexes of platinum, diketone complexes of platinum, and alkyl acetoacetate complexes of platinum. Component (C) should be added in the present method in a quantity that will provide an acceptable acceleration of the hydrosilylation reaction between components (A) and (B), but the quantity of component (C) addition is not otherwise critical. Component (C) is preferably added in a quantity that provides 0.1 to 1,000 weight-ppm catalyst metal in component (C) relative to the overall weight of components (A) and (B).

The following sequences, for example, can be used in the present method to carry out hydrosilylation in which component (B) has been dispersed in microparticulate form in component (A) or component (A) has been dispersed in microparticulate form in component (B): addition of component (C) after components (A) and (B) have been subjected to high-shear agitation; preliminary mixing of components (A) and (C) followed by addition of component (B) and high-shear agitation; preliminary mixing of components (B) and (C) followed by addition of component (A) and high-shear agitation; and high-shear agitation of components (A), (B), and (C). The following sequences are preferred: addition of component (C) after components (A) and (B) have been subjected to high-shear agitation; preliminary mixing of components (B) and (C) followed by addition of component (A) and high-shear agitation; and high-shear agitation of components (A), (B), and (C). The reaction components may be heated as desired or as necessary during the present method. The reaction temperature need merely be a temperature at which the hydrosilylation reaction catalyst is active, for example, preferably 85 to 150° C. and particularly preferably 90 to 105° C.

### EXAMPLES

The present method for preparing organically modified organopolysiloxanes will be explained in additional detail by the working examples provided below. Completion of the hydrosilylation reaction was confirmed by the following colorimetric test procedure.

Colorimetric Test Procedure

2 g of the reactants were diluted with 18 g of ethanol. 10 drops ethanolic silver nitrate solution were added and the change in color was visually monitored. The time from post-silver nitrate addition until the color was observed to be the same as an APHA standard color of 500 was measured.

The following were introduced into a 500-mL three-neck and round-bottom flask: 140 g liquid organopolysiloxane with the formula

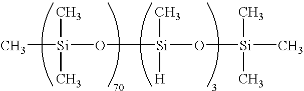

and 50 g of the liquid allyl-monoterminated polyoxyethylene CH₂═CHCH₂O(C₂H₄O)₁₂H. After heating to 100° C., mixing was carried out for 1 minute at 9,000 rpm using a mixing disperser (ULTRA-TURRAX T 25 from IKA Labortechnik) to produce a white emulsion in which the polyoxyethylene was dispersed at an average particle size of 1-20 μm in the liquid organopolysiloxane. Upon the subsequent addition to this white emulsion of a preliminarily prepared mixture of chloroplatinic acid and the aforementioned polyoxyethylene (addition in a quantity that provided 80 ppm platinum metal relative to the overall weight of the liquid organopolysiloxane+polyoxyethylene and that provided the reaction system with 1.2 moles allyl group in the polyoxyethylene per 1 mole silicon-bonded hydrogen in the organopolysiloxane), the hydrosilylation reaction was completed after 1 minute and a transparent solution was obtained. Analysis of this transparent fluid confirmed it to be organically modified organopolysiloxane having the following formula.

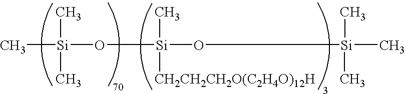

### Comparative Example 1

The procedure of Example 1 was followed, but in this case with mixing for 1 minute at 200 rpm with an anchor-type paddle stirrer instead of the ULTRA-TURRAX T 25 mixing disperser from IKA Labortechnik. A white emulsion was produced in which the polyoxyethylene was dispersed at an average particle size of about 500 μm in the liquid organopolysiloxane. A preliminarily prepared mixture of chloroplatinic acid and the polyoxyethylene (addition in a quantity that provided 80 ppm platinum metal relative to the overall weight of the liquid organopolysiloxane+polyoxyethylene and that provided the reaction system with 1.2 moles allyl group in the polyoxyethylene per 1 mole silicon-bonded hydrogen in the organopolysiloxane) was then added to the white emulsion, but the hydrosilylation reaction was not complete even after 5 minutes. In this case the reaction was completed after 10 minutes; it was confirmed that the same organically modified organopolysiloxane as in Example 1 had been produced.

### Example 2

The following were continuously fed from the top of a rotating disk-equipped rotating disk mixer as disclosed in Japanese Laid Open Patent Application Numbers 2000-449 and 2001-2786: 74 weight parts liquid organopolysiloxane with the formula

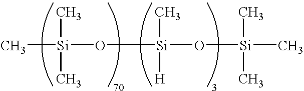

heated to 95° C, 26 weight parts of the liquid allyl-monoterminated polyoxyethylene CH₂═CHCH₂O(C₂H₄O)₁₂H heated to 95° C. (this quantity provided 1.2 moles allyl group in the polyoxyethylene per 1 mole silicon-bonded hydrogen in the organopolysiloxane), and chloroplatinic acid (addition in a quantity that provided 80 ppm platinum metal relative to the overall weight of the liquid organopolysiloxane+polyoxyethylene). A white, transparent mixture was continuously produced from the discharge port at a disk rotation rate of 4,800 rpm. A white emulsion was produced in which the polyoxyethylene was dispersed at an average particle size of 1-20 μm in the liquid organopolysiloxane. The hydrosilylation reaction in this mixture was complete after 1 minute and the mixture was thereby converted to a transparent solution. Analysis of this transparent fluid confirmed it to be organically modified organopolysiloxane with the following formula.

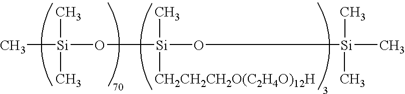

What is claimed is:

1. A solventless method for preparing organically modified organopolysiloxanes by a hydrosilylation reaction comprising reacting
(A) liquid organopolysiloxane that contains at least one silicon bonded hydrogen atom in each molecule with
(B) a non-silicone liquid organic compound that contains at least one aliphatic carbon-carbon double bond in each molecule in the presence of
(C) a hydrosilylation reaction catalyst,
where the hydrosilylation reaction is carried out in a dispersion selected from the groups consisting of (i) component (B) in component (A) and(ii) component (A) in component (B), in a microparticulate form of average particle size ≧100 μm induced by high-shear agitation of components (A) and (B).

2. The method of claim 1, wherein the liquid organopolysiloxane (A) has the following general formula 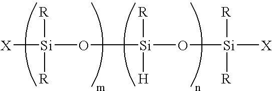
where R denotes an aliphatically saturated monovalent hydrocarbon group, X is selected from the group consisting of (a) a hydrogen atom and(b) an aliphatically saturated monovalent hydrocarbon group, with the proviso that at least one of X is the hydrogen atom when n is 0, m is an integer with a value of at least 0, n is an integer with a value of at least 0, and m+n is an integer with a value of at least 1.

3. The method of claim 1, wherein the non-silicone liquid organic compound (B) is selected from the group consisting of (i) an alkenyl-functional polyether and (ii) an olefin.

4. The method of claim 1, wherein component (B) provides from 1 to 1.4 moles aliphatic carbon-carbon double bonds per 1 mole silicon-bonded hydrogen atoms in component (A).

5. The method of claim 1, wherein component (A) has a viscosity at 25° C. of 1 to 1,000,000 mm²/s.

6. The method of claim 1, wherein component (A) has a viscosity at 25° C. of 1 to 100,000 mm²/s.

7. The method of claim 2, wherein component (A) has a viscosity at 25° C. of 1 to 1,000,000 mm²/s.

8. The method of claim 2, wherein component (A) has a viscosity at 25° C. of 1 to 100,000 mm²/s.

9. The method of claim 2, wherein R selected from the group consisting of methyl and phenyl.

10. The method of claim 2, wherein m is an integer with a value of 1 to 500 and n is an integer with a value from 0 to 30.

11. The method of claim 1, wherein compound (B) has a viscosity at 25° C. of 1 to 1,000,000 mm²/s.

12. The method of claim 1, wherein compound (B) has a viscosity at 25° C. of 1 to 100,000 mm²/s.

13. The method of claim 1, wherein component (C) is a platinum catalyst.
